(19) United States
(12) Patent Application Publication
(10) Pub. No.: US 2025/0377287 A1
(43) Pub. Date: Dec. 11, 2025

(54) A SYSTEM AND A METHOD FOR SENSING A CONDITION OF A COMPONENT

(71) Applicant: HEMPEL A/S, Kongens Lyngby (DK)

(72) Inventor: Vadimas VERDINGOVAS, Kongens Lyngby (DK)

(21) Appl. No.: 18/876,831

(22) PCT Filed: Jun. 30, 2023
(86) PCT No.: PCT/EP2023/067960

§ 371 Date: Dec. 19, 2024

(30) Foreign Application Priority Data
Jul. 1, 2022 (DK) PA202270357

(51) Int. Cl. G01N 17/02

(52) U.S. Cl. CPC G01N 17/02

(57) ABSTRACT

A system for sensing a condition of a component comprising a structure covered by a coating. A first electrical signal and a second electrical signal are communicated to a computer system via a single communication channel, and in the computer system, the signals are separated and subsequently used in combination to provide an indication of the condition of the component or a humidity.

### INTRODUCTION

The invention relates to a system and a method for sensing a condition of a coated structure.

### BACKGROUND

A large variety of structures made e.g., of steel or concrete are covered with coating. Typically, the coating comprises one or more layers of a cured coat. The cured coat may serve different purposes, inter alia protection against atmospheric degradation including corrosion, fading, and UV-caused degradation etc., reduction of fouling, abrasion resistance, chemical resistance, prevention of reflection, or simply providing an aesthetic appearance.

Herein, reference is made to a component comprising a structure with a coating covering a surface of the structure, i.e., the component includes both the structure and the coating.

Under ideal conditions, the coating system exhibits a predefined, intended property, e.g., a specific level of protection against ingress of air, water, or corrosive species, and it therefore preserves the intended condition of the structure. Over time, cracks, or coating degradation, i.e., defects or changes in the one or more layers of cured coat reduce the intended effect, and scheduled maintenance or repair may be necessary.

Embedding conductive electrodes between coating layers is a known principle for detecting barrier properties of the coating and/or corrosion on the surface of the underlying structure. See for example Kittel et al., Progress in Organic Coatings (2001), 41:93-98; Su et al., Corrosion Science (2008), 50:2381-2389.

The use of electrical resistance (ER) or electrical impedance spectroscopy (EIS) to detect coating conditions and corrosion and cracks in the underlying structure is known from literature.

Known environmental sensors can determine environments and parameters including pollutant levels, rainfall, relative humidity, acidity (pH-value), and temperature. Often such parameters characterize corrosive or destructive conditions and can predict a remaining lifetime or a need for preventive activities such a re-coating etc.

When predicting the condition of a coating or a structure, the environmental sensors may improve the prediction based on signals e.g., from ER or EIS sensors. Additionally, signals used by EIS sensors are sometimes adjusted based on temperature and humidity.

Accordingly, many sensors configured for different parameters, e.g., EIS, humidity, and temperature etc, may improve predictability of the condition-particularly, when signals from the different sensors are considered in combination.

The sensors may comprise electrodes applied directly on the surface of the (coated) structure, electrodes applied on the structure under the coating, or electrodes embedded between layers of the coating. For sensors with electrodes applied under the coating or embedded between layers of the coating, the sensors are typically wired through an outer surface of the coating thereby jeopardizing the qualities of the coating to protect against ingress of air and water.

Some computer systems combine different physical properties and based on the properties, they provide an indication of a condition of the component. By means of an example, computer systems exist where temperature and humidity may be combined to predict a coating condition. For this evaluation, the computer system communicates with multiple sensors, and combines signals which are communicated with these sensors. When reading signals from multiple sensor signals, a specific challenge arises. The exactness of the evaluation depends on the reproducible translation from the physical property to an electrical signal representing the physical property. If the signal from each sensor is not always consistently representing the same physical condition, e.g., the same voltage represents the same temperature, the evaluation may be false.

In this respect, signal communication poses a specific challenge. When different signals are communicated by different communication channels, different properties of the channels and different conditions, e.g., temperature, cable length, cable conditions such as humidity or physical shape of the cable etc. may influence the channels differently. Accordingly, the indication of the condition may be based on a signal combination with non-compatible signals. If one signal is communicated by a communication channel in which the properties have changed relative to the properties of the communication channel used for communicating the other signal, then the signal combination may not represent the physical condition in a predictable manner.

Additionally, communication of signals consumes energy. In connection with sensing of conditions of a coated structure, it is typical to use a large amounts of sensors distributed over an area of the coated structure. Often, the sensors are distributed in a larger area and the signal distribution uses long cables extending between a plurality of sensors. The signals are often generated by battery power since the sensors are located far away from electrical grid. Accordingly, energy efficient handling of signals is important.

Additionally, while sensors configured for determining different parameters may improve predictability of the condition, the increased number of wires penetrating the coating may reduce the lifetime. Additionally, the plurality of signals and wires between different types of sensors are difficult to manage in practise and the risk of incorrect connections may lead to false results.

Published applications concerned with monitoring of coated structures include WO2021/028480 and WO2022/043569 both incorporated herein by reference.

### SUMMARY

On this background, it is an object of embodiments disclosed herein to facilitate a more correct distribution of multiple signals which, by the recipient, are to be combined to provide an indication of the condition of a component. It is a further object to provide easier, smarter, and/or faster signal communication without reducing the protective qualities of the coating. It is a further object to reduce the risk of incorrect connections and to make system assembly and data acquisition easier and more efficient. It is a further object to enable multiple sensor readings essentially simultaneously using a single channel of I/O device as part of the computer system. It is a further object to facilitate energy efficient signal communication and allow for extensive use of battery power in sensing systems.

For these and other objects, the disclosure, in a first aspect, provides a system and a method of providing an indication of a condition of a component according to the independent claims and with optional features as specified in the dependent claims.

The system is configured for sensing a condition of a component, e.g., a ship or similar constructions of steel or fibre glass etc, a bridge, or a house etc. Such components may comprise a structure covered by a coating.

The system comprises at least one first sensor configured to convert a first physical property into a first electrical signal, at least one second sensor configured to convert a second physical property into a second electrical signal, at least one additional sensor comprising at least one electrode embedded in the coating and configured to provide at least one additional signal, and a computer system.

The computer system comprises an I/O device having multiple separate channels and a computer unit communicating with the I/O device.

The first sensor and the second sensor are connected to one of the separate channels via a first communication channel, and the additional sensor is connected to another of the separate channels via a second communication channel. Accordingly, the I/O device can communicate AC signals with the first and second sensor via the first communication channel and with the additional sensor via the second communication channel.

The first electrical signal is communicated in a first frequency domain of the first communication channel and the second electrical signal is communicated in a second frequency domain of the first communication channel.

The additional sensor which has at least one electrode embedded in the coating can be used inter alia for ER or EIS evaluation of the coating condition while the first and second signals can be used for other purpose, e.g., for detecting temperature and humidity. Since the signal from the additional sensor is communicated in a separate channel, it can utilise the full spectrum of the frequency sweep without being disturbed by other signals. At same time, the first and second sensors are combined into a single communication channel to reduce the number of communication channels and thereby reduce energy consumption, complexity not least relative to wiring, and reduce the channel numbers and size of the I/O device without reducing the ability to analyse a signal from the additional sensor. Accordingly, the optimal sensing conditions can be preserved with a reduced power consumption and complexity.

Additionally, when a single communication channel communicates both the first and second electrical signal from the two sensors to the computer system, it ensures that both signals are communicated with the same communication conditions. External conditions such as temperature, air pressure, humidity etc. influence a single channel and therefore influence both signals in a more uniform manner. Accordingly, should the communication of the signal affect the signal itself, it affects both signals which are combined by the computer system. This may potentially increase the precision when the signals are subsequently combined by the computer system to provide an indication of the condition of the component.

By physical property is herein considered a property characterizing the environment, for example degradation properties of the component and/or external environmental conditions. One of the first and second signals may represent temperature and the other may represent humidity, or a pollutant level, rainfall, or a corrosive parameter such as a pH or sulphur level, air pressure or other physical properties.

The coating could be constituted by any kind of paint system etc., preferably one or two component paint systems for steel or concrete, such as coating systems for reducing water diffusion. The latter are well known e.g. for pipe protection or protection in water ballast tanks of ships.

The coating may comprise a resin matrix material forming the binder, e.g. an acrylic polymer, an alkyd polymer, or an epoxy polymer. The coating may e.g. comprise the following binders: Acrylic, epoxy, polyaspartic, polyurethane, polysiloxane, alkyd, zinc silicate, silicone, polyuria Hybrid technologies: epoxy/acrylic, epoxy/siloxane, epoxy/zinc silicates.

The coating may comprise a pigment, e.g. providing color or constituting filler material. Any color of the pigment may be considered, e.g. yellow, orange, red, violet, brown, blue, green, or black which are part of the official pigment numbering system e.g. described as pigment white xxx (x=1 to 999), pigment yellow xxx (x=1 to 999), pigment orange (x=1 to 999), pigment red xxx (x=1 to 999), pigment brown (x=1 to 999), pigment violet (x=1 to 999), pigment green (x=1 to 999), pigment blue P.B. (x=1 to 999), pigment black (x=1 to 999) or the like.

Examples of such pigments are: zinc oxide, zinc containing phosphate and polyphosphate, iron oxide, aluminum containing phosphate, zinc borate, graphite, carbon black oxide, coated mica, fluorescent pigments, cuprous oxide, aluminum paste pigment (leafing and non-leafing type), metallic pigments, zinc dust, organic pearl pigment, ammonium polyphosphate, colored silica sand, polyacrylic acid/calcium carbonate, azo-, phthalocyanine and anthraquinone derivatives (organic pigments), and titanium dioxide (titanium (IV) oxide), etc.

The coating may e.g. comprise the following fillers: Carbonates such as: Calcium carbonate, calcite, dolomite (=calcium/magnesium carbonate), magnesium silicate/carbonate, polycarbonate. Included are also mixtures, calcined grades and surface treated grades. Silicates such as: Aluminum silicate (kaolin, China clay), Magnesium silicate (talc, talc/chlorite), Potassium Aluminum silicate (plastorite, glimmer), Potassium Sodium Aluminum silicate (nepheline syenite), Calcium silicate (wollastonite), Aluminum silicate (bentonite), phyllo silicate (mica). Oxides: Silicon dioxide such as quartz, diatomite, metal oxides such as calcium oxide, aluminum oxide, iron oxide and micaceous iron oxide. Hydroxides/hydrates such as: Aluminum hydroxide, Aluminum trihydrate, Sulphates: barium sulphate. Other fillers: Barium metaborate, silicon carbide, Perlite (volcanic glass), Glass spheres (solid and hollow), glass flakes, glass and silicate fibers, organic fibers, polyvinylidene chloride acrylonitrile, polystyrene acrylate.

Included are also mixtures of the above fillers as well as grades which are natural, synthetic, calcined or surface treated.

The coating system could comprise several layers of paint, e.g. including a primer, e.g. an anticorrosive primer applied to the base surface. The base surface could, initially, be treated e.g. by abrasive blasting. On top of one or more layers of primer, the coating may include one or more layers of an intermediate coat such as a coating which promotes adhesion, and/or one or more layers of a top coat. The top coat could e.g. comprise one or more layers of a fouling control surface coating system, which is particularly useful for marine structures. The electrodes could be arranged between such different layers of paint.

The anticorrosive primer could for example be an epoxy-type anticorrosive primer, and it may be a zinc containing or zinc-free primer. An example of an anticorrosive primer with an epoxy-based binder system can be found in WO 2014/032844.

The different layers of paint could be based on epoxy, silicone, or polyurethane and it may include for example a fouling control surface coating system comprising one or more antifouling coats, or a silicone system, where the silicone system can comprise similar or different layers of silicone coatings. An example of a suitable top coat for fouling control can be found inter alia in the patent publication WO 2011/076856.

The I/O device communicates the input and output signal with the sensor having embedded electrodes based on a known principle, e.g. based on electrochemical impedance spectroscopy (EIS) and using e.g. an AC signal. For more information related to EIS, reference is made to for example “Application of electrochemical impedance spectroscopy to study the degradation of polymer-coated metals” by A. Amirudin, D. Thieny, Progress in Organic Coating, volume 26(1):1-28; “Determination of Coating Deterioration with EIS”, F. Mansfeld, C. H. Tsai, Corrosion, 1991, Vol 47 (12): 958-963; “Re-evaluating Electrochemical Impedance Spectroscopy (EIS) for the Field Inspector's Toolbox: A First Approach”; B. J. Merten, A. Skaja, D. Tordonato, D. Little published in United States, Bureau of Reclamation, Research and Development Office. Science and Technology Program, Materials Engineering and Research Laboratory (U.S.) 2014; “Use of Embedded Corrosion Sensors and Sensor Blankets to Detect Paint Degradation”; G. D. Davis and C. M. Dacres, Corrosion 2003, Paper 3441; “Continuous Monitoring of Atmospheric Corrosion and Coating Degradation” D. Ellicks, F. Friedersdorf, M. Merrill, P. Kramer NACE-2017-8834 March 2017. These and several other publications explain the principles of determining deterioration e.g. by use of EIS.

The coated structure may be a CUI structure (Coating under insulation) where the coating is in a non-visible area and the sensor is used to detect degradation of the coating, or under film corrosion. The I/O device may particularly be configured for an AC signal or for a pulse DC signal. In such an implementation, the index may e.g. relate to a combination between two of “water detection”, “coating degradation”, “corrosion”, and/or “cracking”.

The computer system may be configured to extract the first and second electrical signal as separate signals and to use them in combination to provide an indication of the condition of the component. Moreover, the computer system may be configured to use the first and second signals in combination with the at least one additional signal to provide the indication of the condition of the component.

The I/O device may be configured to communicate a data string with a computer unit, wherein the data string comprises a data record for each separate channel. A data record could be a spectrum e.g., from a single frequency sweep. The first and second electrical signals from the first and second sensors may be communicated in a single data record, i.e., e.g., by communicating the response from a single frequency sweep in the form of a single spectrum.

The spectrum is communicated from the I/O device to the computer unit. When this spectrum is received by the computer unit, the first and second signals can be derived from the spectrum and used for providing the indication of the component.

The integration of both signals in a single data record, e.g., represented by the spectrum of a single sweep, simplifies the communication, and reduces the amount of date which is exchanged between the I/O device and the computer unit.

The computer unit may be configured to receive the single data record and carry out the extracting of the first and second electrical signal as separate signals and to use them in combination to provide the indication of the condition of the component. Accordingly, the extraction of the two signals as separate signals does not occur until the data string containing the data record is communicated to the computer unit. This allows a simple communication of data between the I/O device and the computer unit.

An interfacing computer unit may be arranged to receive the data string from the I/O device and to dispatch the data string to the computer unit. The interfacing computer unit may e.g., bundle data from a plurality of I/O devices before the data is transmitted to the computer unit. Particularly, the communication between the I/O device and the interfacing computer unit may use the single data record containing both the first and the second signal in a single data record.

At least one of the I/O device and the interfacing computer unit could be battery operated to allow remote operation far away from a power grid, and to allow easy and fast installation without extensive wiring of power cords. The computer unit may be located remotely, e.g., at a facility with easy access to power, and it may therefore be operated by power from a power grid and not by a battery.

The first signal particularly represent a temperature, the second signal may represent a humidity, and the computer system, particularly the computer unit, is configured to provide a humidity identifier which is an indication of the humidity based both on the second signal and the first signal—i.e., the second signal representing a humidity may be corrected or adjusted based on the measured temperature indicated by the first signal.

This is particularly relevant e.g., when the humidity sensor is a capacity sensor in which the translation from capacitance to temperature depends on temperature.

The computer system is configured to use signals from the at least one additional sensor to provide the indication of the condition of the coating e.g., by ER or EIS. For this purpose, the computer system may use the humidity identifier and the temperature in combination with the ER or EIS signal to improve the indication of the condition.

At least one of the first and second sensors may comprise at least one electrode embedded in the coating. This could e.g., be for temperature measurement, and the embedding of the electrode into the coating may improve the reading of the true temperature of the structure or the coating. This could also be for humidity measurement and thereby enable measurement of humidity inside the coating.

At least one of the first and second sensors may comprise at least one electrode located outside the coating. This may be particularly relevant if the first and second sensors are configured for determining external, environmental, physical properties such as temperature and/or relative humidity, or air pressure etc.

The first and second sensor could both be integrated in a single component such as an integrated circuit (IC). They may e.g., be connected in series or parallel in the IC, and the IC could be embedded in the coating, or it could be located outside the coating, e.g., on a surface of the coating.

If the first and second sensors are implemented in an IC, this IC may additionally be configurated to process date. By means of an example, the IC may carry out pre-processing of the signal, e.g., filtering, before it enters the I/O device and computer unit.

A part of the first communication channel, particularly that part connecting the first and second sensor may be implemented in the IC. Moreover, the IC may be directly attached to the I/O device, e.g., inserted into a motherboard of the I/O device.

The system includes at least one additional sensor. The additional sensors may refer to another category of sensors which are communicated by individual communication channels to individual channels of the I/O device.

In one example, the at least one additional sensor may comprise several sensors, e.g., a third, a fourth, a fifth, and a sixth sensor, or even further sensors.

The third sensor is connected to the computer system via the second communication channel, the fourth, fifth, sixth or further sensors, may also be connected via the second communication channel, or they may be connected via separate, third, fourth, fifth or sixth, communication channels.

These sensers may be used to characterize corrosion for structure monitoring and/or to characterize a coating condition. At least one of the at least one additional sensors may be configured for, and used for ER for detecting corrosion. At least one of the at least one additional sensors may be configured for and used for EIS.

In one example, the at least one additional sensor may comprise a third sensor comprising at least one electrode embedded in the coating, and wherein the computer system is configured to use signals from the third sensor in combination with the signal from the first and second sensors to provide the indication of the condition. In this case, the indication is provided at least partly by ER or EIS and at least partly by the physical properties determined by the first and second sensors.

The signals from the third sensor may particularly represent an EIS-signal indicative of coating degradation.

The ER or EIS sensors may be used to indicate corrosion, degradation, or damage to the structure or coating while the physical properties may be used for validation purpose. In one example, a bad coating condition may be caused by high temperatures and humidity reducing the lifetime of the coating.

The output from the electrodes typically depends on temperature. Particularly, measurement of impedance depends on temperature and may further depend on humidity etc. Additionally, several environmental parameters are indicative for the degradation. Incident sun light, corrosive gases, rainfall, humidity, and temperature all influence the rate of degradation or corrosion of the structure or coating.

Accordingly, the computer system may be configured to use signals from sensor in combination with the signals from the first and second sensors to provide the indication of the condition of the component by ER or EIS combined with environmental parameters such as temperature and humidity etc.

The third sensor may be connected to the computer system via the first communication channel or via a separate, second, communication channel.

The computer system is configured to apply an AC signal over a range of frequencies (a frequency sweep) and the first electrical signal, and the second electrical signal could be a response signal caused by the applied AC signal. The first electrical signal and second electrical signal are frequency dependent, and therefore correspondingly should be read over separate frequency domains. The first and second signals may e.g., constitute a fraction of one and the same sweep whereby both signals are communicated essentially simultaneously, at least with the time delay equivalent to the duration of a single frequency sweep and in a typical range for frequencies between 0.1 Hz and 100 kHz. In the example of 0.1-100 kHz, a frequency sweep over a total of 6 decades with 3-5 points per decade makes 18-30 specific frequencies of interest in each sweep that could be utilised for identification of a signal from a specific one of the two sensors.

Aforementioned data record communicated from the I/O device to the computer unit may particularly be the response from a sweep, herein referred to as a spectrum.

The computer system, and particularly the computer unit, may be configured to distinguish a signal which is propagated through the first communication channel by distinguishing at least one of a resistive, a capacitive, or an inductive component having a frequency dependency, the distinguishing being carried out e.g., during application of the AC signal over a range of frequencies, or later, e.g., when the signal is received by the computer unit. The AC signal may be defined by a current or a voltage, and the distinguishing of the at least one resistive, capacitive, or inductive component, can be carried out in a single frequency sweep of the multiple frequency sweeps.

The alternating signal may be defined by a sinus wave form.

In addition to the first and second signals, the first communication channel may communicate other signals with the computer system, e.g., for determining further environmental parameters, e.g., air-pressure, or tension in the structure etc.

The first electrical signal may have a first impedance characteristic identical to the impedance characteristic of a resistor, and the second electrical signal may have a second impedance characteristic identical to the impedance characteristic of a capacitor. In one embodiment, temperature measurement is represented by ohmic resistance, and humidity measurements are represented by capacitance. Both are derived from the measured impedance modulus and phase, or real and imaginary parts of impedance.

While the first sensor, as mentioned previously, could comprise at least one electrode embedded in the coating, the second sensor may not necessarily comprise any electrode embedded in the coating. In one embodiment, the second sensor is applied for an environmental property not directly linked to the condition of the coating, e.g., a parameter which could have impact on the deterioration, however not being descriptive of the actual condition. Examples of such parameters include rainfall measurements, and incident light measurements etc. In some embodiments, both the first and second sensors comprises electrodes located outside the coating, and as mentioned previously, they could be integrated in a single IC.

The first communication channel could be constituted by a wire and a plurality of sensors with at least one combination of a first sensor and at least one second sensor arranged at different locations on the same wire.

The computer system may be configured to distinguish impedance of each of the plurality of sensors at different locations from the other sensors at other locations by determining, during a single frequency sweep of the multiple frequency sweeps, a fitting of an impedance spectrum according to an equivalent electrical circuit of plurality of sensors and detecting for each sensor a value of impedance and linking the impedance to the physical property.

Accordingly, the computer system may be configured to identify signals from each of the sensors located at different length of the wire away from the computer system, and thus be capable of utilising the signals individually. This will enable the computer system to determine not only the condition or a fault or deterioration of the structure or coating but also to indicate a location of that fault or deterioration along the wire.

In a second aspect, the disclosure provides a method of providing an indication of a condition of the component, the method comprising:
providing a first sensor configured to provide a first signal representing a first physical property;
providing a second sensor configured to provide a second signal representing a second physical property;
providing at least one additional sensor comprising at least one electrode embedded in the coating;
providing a computer system comprising an I/O device having multiple separate channels and a computer unit communicating with the I/O device;
communicating the first electrical signal from the first sensor and the second electrical signal from the second sensor to one of the multiple separate channels of the I/O device via a first communication channel, wherein the first electrical signal is communicated in a first frequency domain of the first communication channel and the second electrical signal is communicated in a second frequency domain of the first communication channel;
communicating an AC signal between the at least one additional sensor and another of the multiple separate channels via a second communication channel, and
using the computer system and the first and second electrical signals in combination with a signal from the at least one additional sensor to provide the indication of the condition of the component.

The computer system may be used for extracting the first and second electrical signal as separate signals for use in combination to provide the indication of the condition of the component.

The functions of the system may be implemented using standard hardware circuits, using software programs and data in conjunction with a suitably programmed digital microprocessor or general-purpose computer, or a cloud computer, and/or using application specific integrated circuitry, and/or using one or more digital signal processors. Software program instructions and data may be stored on a non-transitory, computer-readable storage medium, or in the cloud, and when the instructions are executed by a computer or other suitable processor control, the computer or processor performs the functions associated with those instructions. Accordingly, the disclosure comprises software readable by computer means for carrying out the method and thereby providing the system for sensing a condition of a component.

In a third aspect, the disclosure provides a system for determining humidity, the system comprising at least one first sensor (5) configured to convert a temperature into resistance and at least one second sensor (6) configured to convert a humidity into a capacitance, the system further comprising a computer unit configured to receive signals from the first and second sensor, wherein the computer unit is configured from the signals to determine an impedance, and from the impedance to determine a resistance corresponding to a real part of impedance, and a reactance corresponding to an imaginary part of the impedance, and wherein the computer unit is configured to derive from the resistance a temperature and from the reactance to derive a humidity.

The computer unit may be configured to correct the humidity based on the temperature.

The system may particularly be used in combination with EIS or ER sensing where humidity and/or the temperature may influence the EIS or ER result and the system may therefore be utilised for correcting the result.

### LIST OF DRAWINGS

In the following, embodiments will be described in further details with reference to the drawings in which:

FIGS. 1-3b illustrate a structure with coating and electrodes embedded in the coating and applied on the coating;

FIGS. 4-9b illustrate results of experiments;

FIG. 10 illustrates an example of electrodes constituting sensors; and

FIG. 11 illustrates a system including an interfacing computer.

### DESCRIPTION OF EMBODIMENTS

The detailed description and specific examples, while indicating embodiments, are given by way of illustration only, since various changes and modifications within the scope of the claims will become apparent to those skilled in the art from this detailed description.

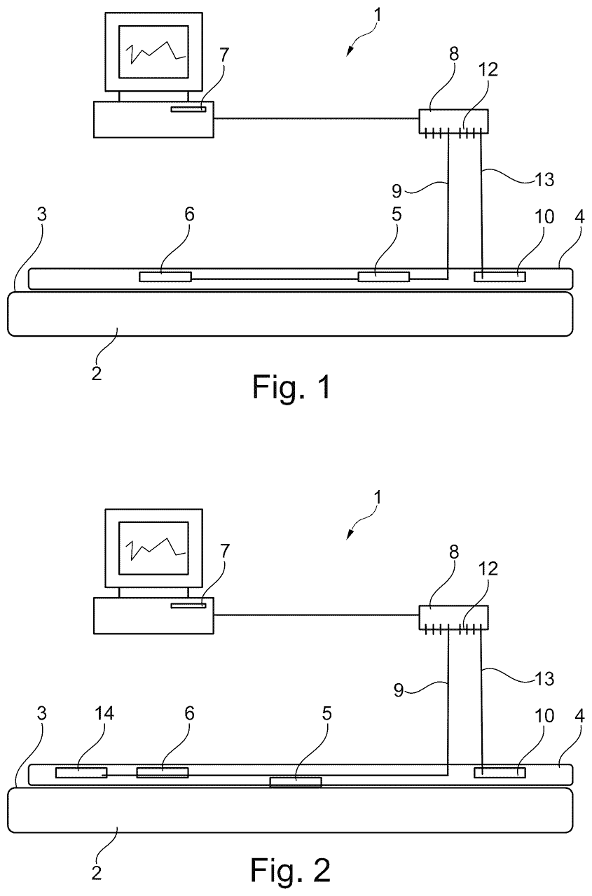

FIG. 1 illustrates a system 1 for sensing a condition of a component. The component comprises a structure 2 having a surface 3 covered by a coating 4.

The system comprises at least one first sensor 5 constituted by an electrode embedded in the coating. The first sensor 5 is configured to convert a first physical property into a first electrical signal.

The system further comprises at least one second sensor 6 constituted by an electrode embedded in the coating. The second sensor is configured to convert a second physical property into a second electrical signal.

The system comprises a computer system comprising a computer unit 7 and an I/O device 8. The computer system communicates with the sensors via a first communication channel constituted by the wire 9 which connects the first sensor and the second sensor to the computer system. The I/O device handles input and output and it is realised by a combined multiplexer and potentiostat inserted between the computer unit 7 and the sensors 5, 6.

The multiplexer and potentiostat communicates an AC signal with the sensors by inducing a signal into the sensor and reading an output signal from the sensor. The I/O energises the wire 9 and transmits the received response signal from the wire 9 to the computer unit 7 as a data record in a data string.

The I/O device may e.g., be configured for an AC output signal with a frequency of e.g., 10 μHz up to 1 MHz such as between 0.1 Hz and 200 kHz. The I/O device may be configured for a current range or 100 pA to 100 mA, and a potential range of ±2V, e.g. typical range between 10 mV to 1V with default value of 50 mV.

To enable communication between the two or more sensors using only a single communication channel, the communication is based on a first frequency domain of the first communication channel and a second frequency domain of the first communication channel, each being utilized for communication of a signal with one specific sensor.

As shown, it may be in wired connection with the electrodes of the sensor-alternatively, it may communicate wirelessly with the electrodes. Wireless communication enables complete embedment of the sensor in the coating and thereby provides a more robust system still utilizing the advantage of using only a single communication channel thereby simplifying the communication.

The I/O device 8 communicates electrical signals with the computer unit 7, and the computer unit is configured to derive a condition of the coating, a condition of the structure, or a condition of the interface between the structure and the coating, i.e., a condition of the component from the electrical signal from the sensors.

The I/O device 8 may communicate the response signal or a signal derivable from the response signal to the computer unit 7, and it may comprise an internal storage to allow intermittent communication with the computer unit 7. By inclusion of an internal storage, the local CPU-unit further defines a data logger which can log the data from the sensor. The data logging may also be carried out in a separate computer unit between the I/O device and the computer unit 7. As an alternative to, or in combination with the illustrated local computer unit 7, cloud computing and/or a cloud data storage may be used for processing and data storage.

The I/O device may e.g., be constituted by a PalmSens4™ from the company PalmSens, or potentiostat/Galvanostat CS350 from the company Corrtest Instruments, or similar commercially available potentiostat, galvanostat or similar impedance analysing devices. Additionally, it may comprise a multiplexer to share the signal between a plurality of sets of electrodes. Another available potentiostat could be Ivium, PocketSTAT2, from the company Ivium Technologies. Alternatively, a proprietary, custom made Potentiostat and multiplexer unit may be implemented, e.g., including an integrated communication module (LoRa) and e.g., powered by a battery.

The I/O device has a number of separate I/O channels 12 and the first communication channel 9 is attached to one of these separate channels.

The system comprises an additional sensor 10 comprising an electrode embedded in the coating and wired by a separate communication channel 13 to a separate one of the I/O channels 12.

The computer unit 7, e.g., in the form of a local computer unit and/or in form of a cloud computer, is configured for further processing of the response signal, configured for presentation of a result based on the response signal, or for collecting and optionally comparing and/or presenting response signals from a plurality of I/O devices each connected to two or more patterns via a bus-wiring. The computer system also includes a data logger for gathering the collected data.

Based on the response signal, two different output signals are determined at different positions of a frequency sweep.

During a frequency sweep, a set of response signals comprised of impedance modulus and phase angle are obtained for a number of frequencies. The impedance modulus, consisting of a real and imaginary parts can be also defined as:

$$\vert Z \vert = \sqrt{{R}^{2} + {X}^{2}} \qquad ( 1 )$$

Where R is resistance and corresponds to the real part of impedance, and X is reactance and corresponds to the imaginary part of the impedance. The relationship between resistance and reactance can be expressed via phase angle φ as following:

$$φ = arctan ( \frac{X}{R} ) \qquad ( 2 )$$

Resistance and reactance can be described accordingly:

$$R = \vert Z \vert cos φ and X = \vert Z \vert sin φ \qquad ( 3 and 4 )$$

For a resistance-based sensor, the impedance would be purely resistive, exhibiting no phase shift (0°), and impedance would be independent of frequency.

For a capacitance basted sensor, the impedance would be purely reactive, exhibiting 90° phase shift, and impedance would be inversely proportional to the applied signal frequency.

For a combination of resistance and capacitance-based sensors connected in series or in parallel, a frequency sweep would provide a set of impedance and phase values dependent on frequency. Phase angle vs frequency graph, in this case, could serve as indication of the frequency domains wherein capacitive and resistive impedance is dominant. Analysis of resistance (real part of impedance) and reactance (imaginary part of impedance) within respective frequency domains wherein impedance of a particular sensor in a circuit is dominant, would allow to distinguish both resistance and capacitance each corresponding to a particular environmental sensor in a single frequency sweep using a single communication channel.

Alternatively, determination of resistance and reactance of electrical circuit could be done utilizing commonly used equivalent circuit analysis and fitting. More information on equivalent circuit fitting could be found elsewhere, c.f. Kittel et al., Progress in Organic Coatings (2001), 41:93-98; Su et al., Corrosion Science (2008), 50:2381-2389.

FIG. 2 illustrates an embodiment further comprising a fourth sensor 14 comprising at least one electrode embedded in the coating. The computer system is configured to use signals from the third sensor in combination with the signal from the first and second sensors to provide the indication of the condition. In this case, the indication is provided at least partly by EIS or ER and at least partly by the physical parameter. One of the electrodes 5, is attached directly to a surface of the structure under the coating. The other sensors 6, 10 and 14 each comprises an electrode embedded in the coating, i.e., in contact with coating on all surfaces.

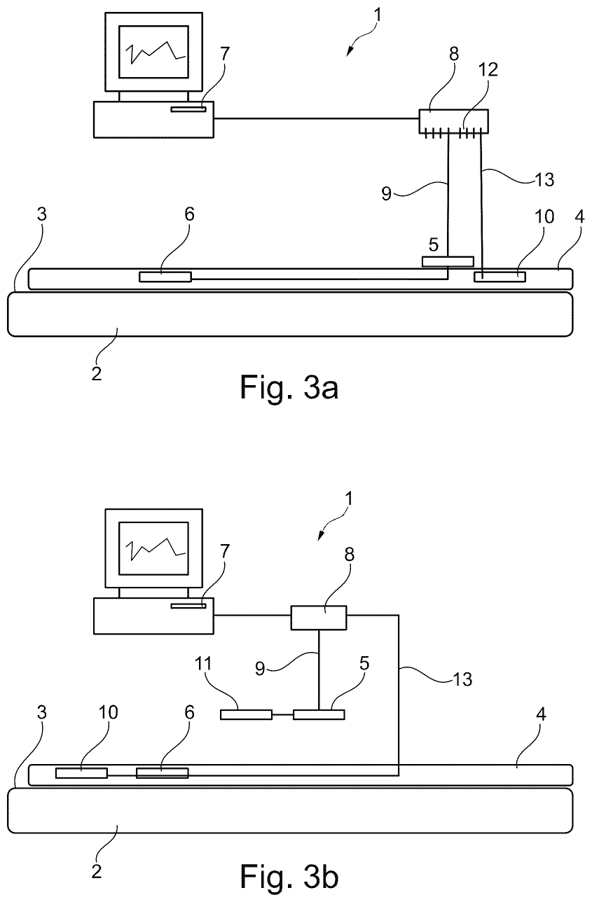

FIG. 3a illustrates an embodiment wherein one sensor 5 comprises an electrode located outside the coating, in this example attached to the surface of the coating, and the other sensors 6 and 10 each comprises an electrode embedded in the coating. The two sensors 5 and 6 communicate on a common communication channel 9.

FIG. 3b illustrates an embodiment wherein the first communication channel is connected to the first sensor 5 and a second sensor 11, located outside the coating, while the second communication channel is connected to the other sensors 6 and 10 comprised of electrodes embedded in the coating. The sensors comprised of non-embedded electrodes may e.g., determine humidity and temperature external to the coating and the sensors comprised of embedded electrodes may be EIS or ER sensors and determine the condition of the coating and/or of underlying structure.

If the first signal represents a temperature and the second signal represents a humidity, the computer system may be configured to provide a humidity identifier based both on the second signal and the first signal.

In below table 1 is provided an example of a specific capacitive humidity sensor, with a nominal capacitance of 300 pF±40 pF (at 30% RH and 23° C.). The capacitance of the sensor is dependent on RH with the sensitivity of 0.45 pF/% RH. The sensor capacitance is also dependent on temperature, for which it must be corrected to have accurate RH readings. Temperature dependency is further described as:

$$Δ \% RH = ( B 1 \times \% RH + B 2 ) \times T [ ° C . ] + ( B 3 \times \% RH + B 4 ) , \qquad ( 5 )$$

$$where$$

$$B 1 = 0.0011 [ 1 / ° C . ] ;$$

$$B 2 = 0.0892 [ \% RH / ° C . ] ;$$

$$B 3 = - 0.0268 ;$$

$$B 4 = - 2.079 [ \% RH ] .$$

Δ % RH described by equation (5) could be considered as RH error, if not corrected for.

Table 1 shows an example of RH error which is calculated using equation (5), and as a function of T and for three levels of RH namely 20%, 40% and 60%.

TABLE 1
Example of T correction of RH reading. Both
sensors can be read using single channel.

| T/° C. | Δ % RH at 20% RH | Δ % RH at 40% RH | Δ % RH at 60% RH |
|---|---|---|---|
| 0 | −2.615 | −3.151 | −3.687 |
| 10 | −1.503 | −1.819 | −2.135 |
| 20 | −0.391 | −0.487 | −0.583 |
| 30 | 0.721 | 0.845 | 0.969 |
| 40 | 1.833 | 2.177 | 2.521 |
| 50 | 2.945 | 3.509 | 4.073 |
| 60 | 4.057 | 4.841 | 5.625 |
| 70 | 5.169 | 6.173 | 7.177 |
| 80 | 6.281 | 7.505 | 8.729 |
| 90 | 7.393 | 8.837 | 10.281 |
| 100 | 8.505 | 10.169 | 11.833 |
| 110 | 9.617 | 11.501 | 13.385 |
| 120 | 10.729 | 12.833 | 14.937 |
| 130 | 11.841 | 14.165 | 16.489 |
| 140 | 12.953 | 15.497 | 18.041 |
| 150 | 14.065 | 16.829 | 19.593 |
| 160 | 15.177 | 18.161 | 21.145 |
| 170 | 16.289 | 19.493 | 22.697 |
| 180 | 17.401 | 20.825 | 24.249 |
| 190 | 18.513 | 22.157 | 25.801 |

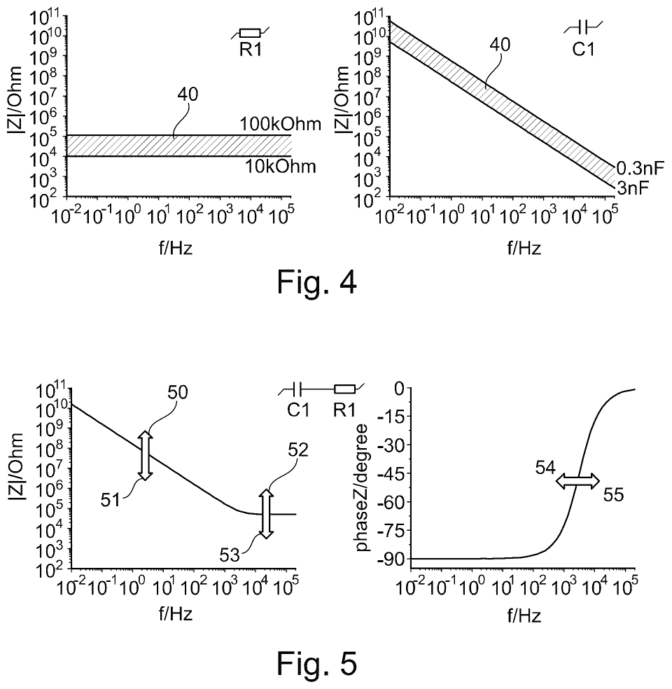

FIG. 4 illustrates an example of impedance vs frequency response for
a. a single resistor, and
b. a single capacitor

These components could represent physical sensors e.g., for temperature and humidity sensing. The area 40 in the graphs indicate an exemplary range wherein impedance could change as response to change of sensing parameter.

The impedance dependency on frequency of a resistor and a capacitor is described as follows:

$$Z ( f ) = {R}_{1} \qquad ( 1 )$$

$$Z ( f ) = \frac{1}{{C}_{1} j 2 π f} \qquad ( 2 )$$

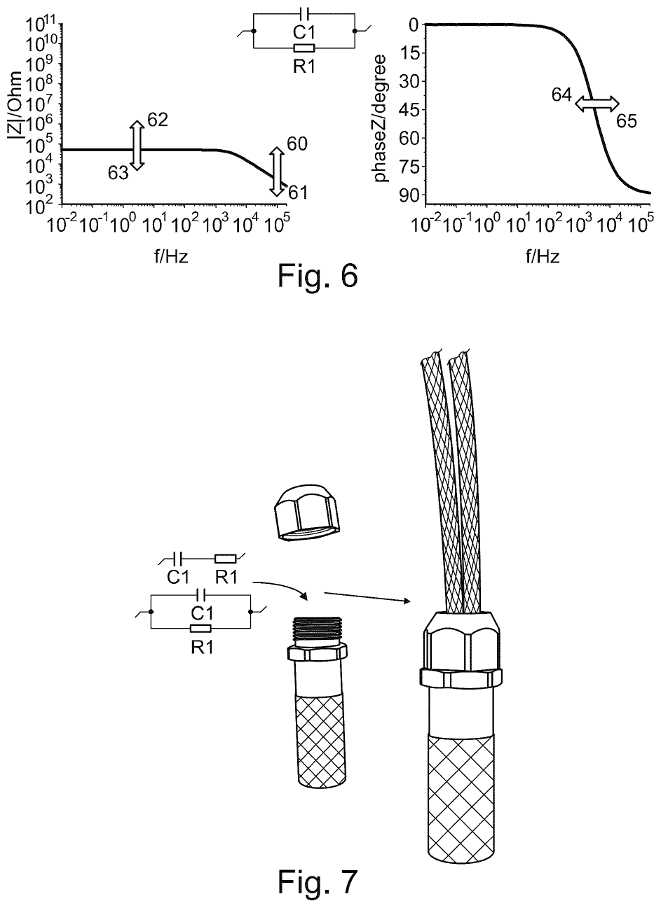

As it can be seen from FIG. 4, and equations (6) and (7), impedance of a resistor is independent of frequency, while impedance of a capacitor decreases with frequency. Provided that two components are connected in a circuit in series or in parallel, the corresponding impedance could be determined in different frequency domains. This is visualized in FIG. 5 and FIG. 6.

FIG. 5 is a bode plot of a 1 nF capacitor connected in series with a 50 kOhm resistor and FIG. 6 is a bode plot of a 1 nF capacitor connected in parallel with a 50 kOhm resistor.

In FIG. 5, the upwards arrow 50 indicates decrease of capacitance and the downwards arrow 51 indicates increase capacitance. The upwards arrow 52 indicates increase of resistance and the downwards arrow 53 indicates decrease of resistance. The left pointing arrow 54 indicates increase of capacitance and/or resistance, and the right pointing arrow 55 indicates decrease of capacitance and/or resistance.

In FIG. 6, the upwards arrow 60 indicates decrease of capacitance and the downwards arrow 61 indicates increase capacitance. The upwards arrow 62 indicates increase of resistance and the downwards arrow 63 indicates decrease of resistance. The left pointing arrow 64 indicates increase of capacitance and/or resistance, and the right pointing arrow 65 indicates decrease of capacitance and/or resistance.

In both FIG. 5 and FIG. 6:
a. Impedance modulus vs frequency
b. Phase vs frequency

Below equations 8 and 9 describe impedance dependency on frequency of a capacitor connected with a resistor in series and in parallel accordingly:

$$Z ( f ) = {R}_{1} + \frac{1}{{C}_{1} j 2 π f} \qquad ( 8 )$$

$$Z ( f ) = \frac{{R}_{1}}{j 2 π f {R}_{1} {C}_{1}} \qquad ( 9 )$$

Based on the visualization in FIGS. 3 and 4, by varying resistor and capacitor values connected in a circuit in series or in parallel, a change of the corresponding frequency domain wherein the impedance of each component is dominant, occurs.

This is indicated by arrows in the graphs of FIGS. 5 and 6. Change of resistance or capacitance of the sensors would shift both the impedance and the range of frequencies wherein corresponding values could be read.

Based on this concept, it is possible to tailor the value of each resistor and capacitor, connected either in series or in parallel to a single channel, making it possible to distinguish both parameters in a single frequency sweep, when reading corresponding resistance and capacitance values over different frequency domains.

For example, for a series connection of R and C, corresponding to the graph in FIG. 5, increasing of resistor value shifts the frequency domain wherein the resistive impedance is dominating towards the lower frequencies, while lowering the resistance down to 100 Ohm, shifts the frequency domain towards higher frequencies which makes it barely detectable in the given frequency range of the spectrum. Similar effect could be achieved by varying a capacitor value.

The tailoring of resistance or capacitance values, each of which could correspond to physical sensors, enables measurement of a combination of sensors within a single impedance sweep. Following this concept, it is possible to use multiparameter sensing system with use of only a single measurement channel, referred to herein as the first communication channel.

Examples of such systems with sensors comprising embedded electrodes are:

$$Series connection of coating degradation sensor ( parallel RC ) + Temperature sensor ( R )$$

$$Series connection of coating degradation sensor ( parallel RC ) + crack / mechanical damage sensor ( R )$$

$$Series connection of coating degradation sensor ( parallel RC ) + Corrosion sensor ( R )$$

Examples of such systems with external sensor (i.e., with electrodes not being embedded in the coating) are:

$$Series of parallel connection of humidity sensor ( C ) + Temperature sensor ( R )$$

$$Series of parallel connection of Pressure sensor ( C ) + Temperature sensor ( R )$$

$$Series of parallel connection of humidity / gas sensor ( C ) + Corrosion sensor ( R )$$

This method is not limited to the examples provided above, and can be used with a variety of conventional sensor types which have R, C, or L dependency on sensing parameters.

### Experiment

The concept was validated on an in-house made temperature and relative humidity probe (T/RH dual sensor), where a commercial T sensor with positive temperature coefficient and 10 kOhm nominal resistance was connected in series with a commercial capacitive humidity sensor with nominal value of 300 pF.

The RH sensor is an MK33-W by Innovative sensor technology IST AG with a nominal capacitance of 300 pF±40 pF.

The Temperature sensor is a TMP61-Q1 thermistor by Texas Instruments, with 10 kOhm nominal resistance and in a TO-92S package. As alternative to the thermistor used in this example, a resistance temperature detector (RTD) with nominal resistance of 10 kOhm could be used. This would further improve the accuracy and extend the service temperature range of the sensor.

Both sensors can be used in temperatures up to 200 degrees Celsius making it suitable for monitoring T and RH conditions in different applications, inter alia in coatings arranged under insulative layers, in short CUI (for detection of corrosion under insulation).

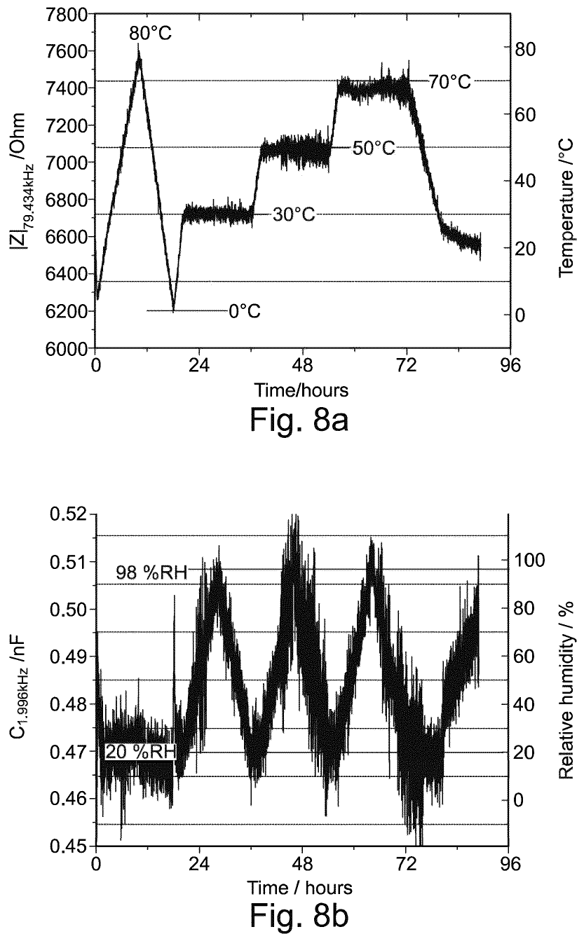

FIG. 7 is a drawing illustrating an actual sensor and housing being tested, and FIGS. 8a and 8b illustrate a temperature and relative humidity measurement obtained with a single channel dual sensor comprised of 10 kOhm positive temperature coefficient thermistor and 300 pF capacitive humidity sensor.

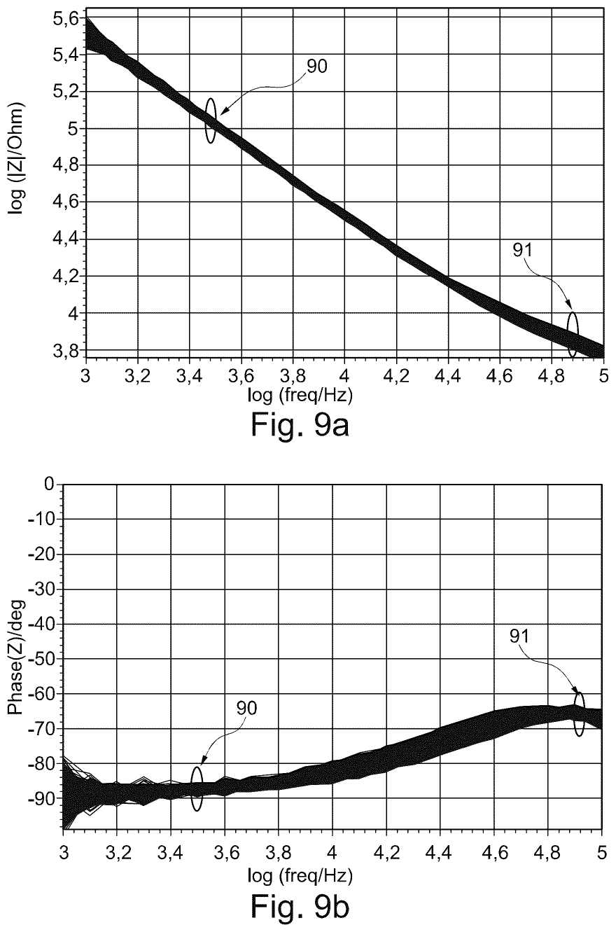

For the validation of the dual sensor concept, the assembled T/RH sensor was exposed to varying T and RH profile, and the impedance over a range of frequencies was continuously measured. The measurements consisting of multiple frequency sweeps (spectra) taken throughout the test are shown in FIGS. 9a and 9b.

FIGS. 9a and 9b are bode plots of dual T/RH sensor obtained throughout the test. “RH reading” indicated by arrow 90 and “T reading” indicated by arrow 91 in the graphs indicate respective frequency domains wherein T and RH readings were taken for constructing the graphs shown in FIGS. 8a and 8b.

In FIGS. 8a and 8b, temperature and relative humidity are accordingly shown on the ordinate, Y-axis. The direct relation between impedance and temperature and relative humidity at different frequency domains as measured by two different sensors connected in series shows the practical use for communication on a single communication channel.

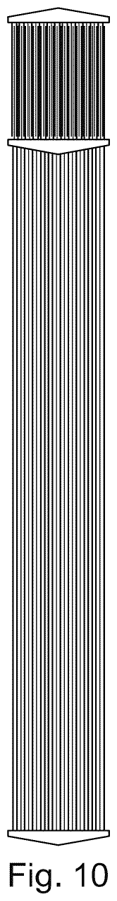

FIG. 10 illustrates an electrode layout considered for the first and second sensor. The depicted layout could represent: i) an EIS sensor for coating degradation+a resistance-based crack sensor or ER electrode connected in series, and ii) electrodes for EIS sensor for coating degradation+temperature sensor, both electrodes to be embedded within the coating. The latter configuration may improve the accuracy of an embedded electrode for estimation of a coating condition since impedance has strong dependency on temperature. This layout would also eliminate the need for separate and externally mounted temperature sensors. Further layouts of electrodes for sensors can be found inter alia in WO 2021/028480, e.g., in FIGS. 10-14.

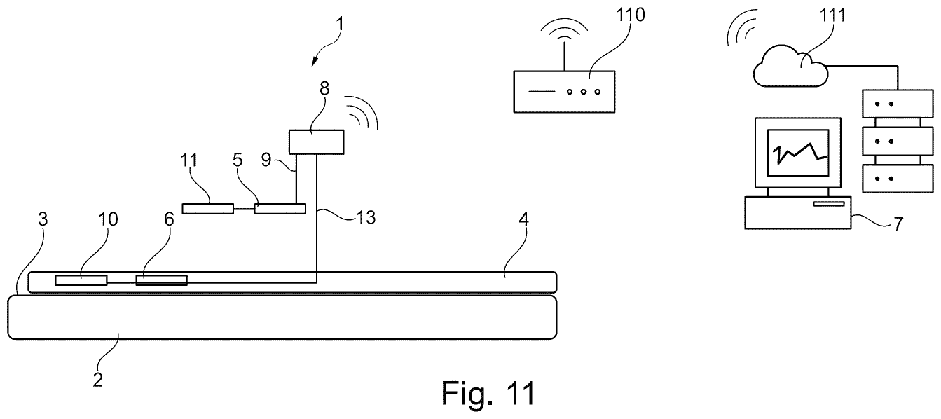

FIG. 11 illustrates a setup with a battery powered I/O device 8 communicating electrical signals with a gateway 110. The gateway could be a LoRaWAN gateway communicating with the battery powered I/O device and communicating with a database, e.g., with a cloud-based database 111. The computer unit 7 is in communication with the database 111 and can read and visualise the electrical signals and can extract the first and second electrical signals as separate signals and use them in combination to provide the indication of the condition of the component.

The illustrated I/O device may e.g., have 8 input/output channels and it may be configured to measure impedance over a range of frequencies. The I/O device could be ATEX certified and may be powered by non-rechargeable batteries. The electric charge consumption of the device determines the operation time of the device before the batteries must be replaced. The device consumes electric charge stored in the battery during:
i) measurements of the sensors connected through wire connections, and
ii) during transmittance of the data through the LoRaWAN gateway.

Electric charge consumed during measurements is dependent on frequencies and overall number of frequencies per impedance spectrum. Lower frequencies take longer time to measure, thus consumes more charge over time (mAh), see table 3:

Electric charge consumption during data transmittance is dependent on the spreading factor, which is linked to the emission power and transmission speed which is determined by the network conditions between I/O device and LoRaWAN gateway.

Below table 1 and table 2 illustrate measurement expense with different frequency ranges in a spectrum, and sending expense with different spreading factors, SF.

TABLE 2
Measurement expense shown for different
frequencies of impedance spectrum.

| Range [Hz] | Time [s] | Current [mA] | Charge [mAh] |
|---|---|---|---|
| 0.3125-0.6249 | 66 | 15 | 0.275 |
| 0.625-1.249 | 33 | 15 | 0.1375 |
| 1.25-2.49 | 22.3 | 15 | 0.09292 |
| 2.5-4.99 | 11.3 | 15 | 0.04708 |
| 5-1023 | 3.5 | 15 | 0.01458 |
| 1024-250000 | 0.45 | 15 | 0.00188 |

TABLE 3
Sending expense shown for various spreading factors.

| Spreading factor | Time [s] | Current [mA] | Charge [mAh] |
|---|---|---|---|
| SF12 | 1.5 | 56 | 0.02333 |
| SF11 | 0.75 | 56 | 0.01167 |
| SF10 | 0.375 | 56 | 0.00583 |
| SF9 | 0.19 | 56 | 0.00296 |
| SF8 | 0.1 | 56 | 0.00156 |
| SF7 | 0.05 | 56 | 0.00078 |

### Example of Charge Consumption

The following example illustrates the charge consumption and the saving obtained by using the first communication channel for communication both with the first and the second sensor. The example is based on an 8 channel I/O device and the setup illustrated in FIG. 11.

Total charge consumption (current multiplied by the time) of an I/O device is a sum of charge used of measurement and charge used for data transmittance plus minor consumption when device is not active (approximately 0.006 mA multiplied by the total time).

For an example, when all 8 channels of I/O devices are configured to acquire impendence spectra each comprised of 16 frequencies i.e., 100 kHz, 25 kHz, 12.5 kHz, 6.25 kHz, 3.125 kHz, 1.562 kHz, 780 Hz, 390 Hz, 190 Hz, 90 Hz, 40 Hz, 20 Hz, 10 Hz, 5 Hz, 1 Hz, the time required to complete measurement of all frequencies once would take 575.6 seconds (calculated using data shown in Table 1).

Assuming the data is transmitted using spreading factor SF6. Transmitting the data would take 24.32 seconds (calculated using data shown in table 3).

The total charge used to measure all 8 channels of I/O device and transmit the data would be:

$$C = \frac{{t}_{measurement} \cdot 15 mA + {t}_{SF 9} \cdot 56 mA}{3600 s} = \frac{575.6 + 24.32 \cdot 56}{3600} = 2.776 mA h$$

This gives a charge consumption per channel 0.347 mAh. This is the battery saving that can be achieved when measuring several sensors with a single channel of an I/O device.

For the case when the total charge supplied by the batteries is 5200 mAh, measurements and transmittance of the data of all channels can be executed 1873 times. If the same amount of information can be obtained using 7 channels instead of 8, the measurements can be completed 2140. Or alternativity all 8 channels could be used, thereby more sensors would be measured using the same charge consumption. The actual number of measurements would be slightly less due to a minor consumption of charge when device is not active, which for simplification is not included in this example.

The examples above are for indicative purpose only. Irrespectively of the frequencies measured per spectrum, or spreading factor used to transmit the data, reducing number of channels required to measure the same number of sensors would result in saving of charge consumption, and thus extend the operation time of the I/O device.

Secondary advantage of several sensor's measurement using single channel is reduction of data sets in the database, which also reduces data processing time.

1.-28. (canceled)

29. A system for sensing a condition of a component comprising a structure covered by a coating, the system comprising at least one first sensor configured to convert a first physical property into a first electrical signal, at least one second sensor configured to convert a second physical property into a second electrical signal, at least one additional sensor comprising at least one electrode embedded in the coating and configured to provide at least one additional signal, and a computer system, the computer system comprising an I/O device having multiple separate channels and a computer unit communicating with the I/O device, wherein:
the first sensor and the second sensor are connected to one of the separate channels via a first communication channel, and the additional sensor is connected to another of the separate channels via a second communication channel such that the I/O device can communicate AC signals with the first and second sensor via the first communication channel and with the additional sensor via the second communication channel, and
the first electrical signal is communicated in a first frequency domain of the first communication channel and the second electrical signal is communicated in a second frequency domain of the first communication channel,
wherein the first signal represents a temperature, the second signal represents a humidity, and the computer system is configured to provide a humidity identifier being an indication of the humidity based both on the second signal and the first signal,
wherein the computer system is configured to apply an alternating signal over a range of frequencies applied in multiple frequency sweeps and wherein the first electrical signal and the second electrical signal are included in a response from the alternating signal, and
wherein the computer system is configured to distinguish the first signal from the second signal by distinguishing at least one of a resistive, a capacitive, or an inductive component having a frequency dependency.

30. The system according to claim 29, wherein the computer system is configured to extract the first and second electrical signal as separate signals and to use them in combination to provide an indication of the condition of the component.

31. The system according to claim 30, wherein the computer system is configured to use the first and second signals in combination with the at least one additional signal to provide the indication of the condition of the component.

32. The system according to claim 29, wherein the I/O device is configured to communicate a data string with a computer unit,
wherein the data string comprises a data record for each separate channel and wherein the first and second electrical signal is communicated in a single data record.

33. The system according to claim 32, wherein the data record is a spectrum of a frequency sweep.

34. The system according to claim 34, wherein the computer unit is configured to receive the single data string and carry out the extracting of the first and second electrical signal as separate signals and to use them in combination to provide the indication of the condition of the component.

35. The system according to claim 29, wherein the I/O device is battery operated and the computer unit is operated by power from a power grid.

36. The system according to claim 29, wherein the computer system is configured to use signals from the at least one additional sensor to provide the indication of the condition of the coating by EIS.

37. The system according to claim 36, wherein the indication is based on the humidity identifier and temperature.

38. The system according to claim 29, wherein at least one of the first and second sensors comprise at least one electrode embedded in the coating.

39. The system according to claim 29, wherein at least one of the first and second sensors comprises at least one electrode located outside the coating.

40. The system according to claim 29, wherein the first and second sensor are integrated in a single component.

41. The system according to claim 40, wherein the single component is an integrated circuit (IC).

42. The system according to claim 41, wherein the first and the second sensor is connected in series or parallel in the IC.

43. The system according to claim 40, wherein the single component is located outside the coating.

44. The system according to claim 29, wherein the distinguishing of the at least one resistive, capacitive, or inductive component, is carried out for a signal representing a single frequency sweep.

45. The system according to claim 29, wherein the first electrical signal has a first impedance characteristic identical to the impedance characteristic of a resistor, and the second electrical signal has a second impedance characteristic identical to the impedance characteristic of a capacitor.

46. The system according to claim 29, comprising a plurality of sensors comprising several combinations of the first sensor and the second sensor arranged at different locations along the first communication channel.

47. The system according to claim 46, wherein the computer system is configured to distinguish impedance of each of the plurality of sensors at different locations from the other sensors at other locations by determining, during a single frequency sweep of the multiple frequency sweeps, a fitting of an impedance spectrum according to an equivalent electrical circuit of plurality of sensors and detecting for each sensor a value of impedance and linking the impedance to the physical property.

48. The system according to claim 29, wherein the first sensor is configured to convert a temperature into resistance and at least one second sensor is configured to convert a humidity into a capacitance,
wherein the computer unit is configured from the signals to determine an impedance, and from the impedance to determine a resistance corresponding to a real part of impedance, and a reactance corresponding to an imaginary part of the impedance, and
wherein the computer unit is configured to derive from the resistance a temperature and from the reactance to derive a humidity.

49. The system according to claim 48, wherein the computer unit is configured to correct the humidity based on the temperature.

50. A method of providing an indication of a condition of a component comprising a structure covered by a coating, the method comprising:
providing a system according to claim 29;
communicating the first electrical signal from the first sensor and the second electrical signal from the second sensor to one of the multiple separate channels of the I/O device via a first communication channel,
wherein the first electrical signal is communicated in a first frequency domain of the first communication channel and the second electrical signal is communicated in a second frequency domain of the first communication channel;
communicating an AC signal between the at least one additional sensor and another of the multiple separate channels via a second communication channel, and
using the computer system and the first and second electrical signals in combination with a signal from the at least one additional sensor to provide the indication of the condition of the component.

51. The method according to claim 50, comprising using the computer unit to extract the first and second electrical signal as separate signals for use in combination with the signal from the additional sensor to provide the indication of the condition of the component.

52. The method according to claim 50, wherein the first electrical signal is considered as a signal from a parallel Resistor/Capacitor coupling and the signal is applied for determining a coating degradation, a humidity, a pressure, or a gas content.

53. The method according to claim 50, wherein the second signal is considered as a signal from a resistor and is applied for determining a temperature, crack/mechanical damage, or corrosion.
